(19) United States
(12) Patent Application Publication
(10) Pub. No.: US 2007/0282761 A1
(43) Pub. Date: Dec. 6, 2007

(54) SYSTEM AND METHOD TO CALCULATE TAX LIABILITY OF A FOREIGN ENTITY

(75) Inventors: David L. Deputy, Alameda, CA (US); Ricardo G. Samaniego, Los Altos, CA (US)

Correspondence Address: SCHWEGMAN, LUNDBERG & WOESSNER, P.A., P.O. BOX 2938, MINNEAPOLIS, MN, 55402, US

(73) Assignee: Liquid Engines, Inc.

(21) Appl. No.: 11/421,746

(22) Filed: Jun. 1, 2006

(51) Int. Cl. G06Q 40/00

(52) U.S. Cl. 705/36 T

(57) ABSTRACT

A system receives business data pertaining to a first entity where the first entity is associated with a second entity. The system creates first tax data associated with the second entity based on the business data and a first business form of the first entity. The system then creates second tax data associated with the second entity based on the business data and a second business form of the first entity and stores the first tax data and the second tax data.

### FIELD

This application relates to a method and system to calculate the US tax liability associated with a foreign entity by calculating, according to one embodiment, a first and second set of tax data associated with making an election to change the foreign entity's business form for US tax entity characterization.

### BACKGROUND

Jurisdictions may vary in how a parent entity treats a child entity's (e.g., a foreign subsidiary) data, such as income, expenses, losses, credits, etc., for taxation purposes. How this data is treated depends on how the parent entity classifies the child entity's business form for taxing the parent in the parent's jurisdiction. For example, income from a child entity in the business form of a corporation is treated differently than income from a child entity in the business form of a partnership with respect to taxing the parent.

In one instance, a child corporation may choose to hold the income in its jurisdiction or elect to pay a dividend to the parent in the parent's jurisdiction. Alternatively, a child partnership or branch, commonly referred to as “flow-through entities” (FTEs), may immediately flow any generated income to the parent in its jurisdiction. Each case may have its advantages depending on the parent entity's tax strategy.

Traditionally, a change in election of treatment of a child entity with respect to the parent entity is accomplished through a manually intensive data transfer based on a closing of the original business form and transfer of the earnings, profits and assets to the newly elected and created business form.

### BRIEF DESCRIPTION OF DRAWINGS

The present invention is illustrated by way of example and not limitation in the figures of the accompanying drawings, in which like references indicate similar elements and in which:

FIG. 1 is a diagram that illustrates an example embodiment of a tax computing system, which may be used to compute taxation data for a domestic entity or consolidated group of domestic entities based on business data associated with a change in a related entity's business form;

FIGS. 2A and 2B are diagrams graphically illustrating a relationship with respect to tax treatment of an entity and its associated related entities;

FIG. 3 is a block diagram illustrating an example embodiment of modules that may be used in an election event by the tax computing system;

FIG. 4 is a flowchart illustrating the operations in an example embodiment for an election event to treat an elected entity in a first jurisdiction as a different business form for taxation purposes of its parent entity in a second jurisdiction;

FIG. 5 is screenshot, according to one embodiment, illustrating the input selections for electing to treat a foreign corporation as a flow through entity;

FIG. 6 is a screenshot, according to one embodiment, illustrating the selectable results of the election from a corporate to a flow through entity;

FIG. 7 is a screenshot illustrating an example embodiment of a user interface provided to a user for electing to treat a foreign flow through entity as a corporation; and

FIG. 8 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

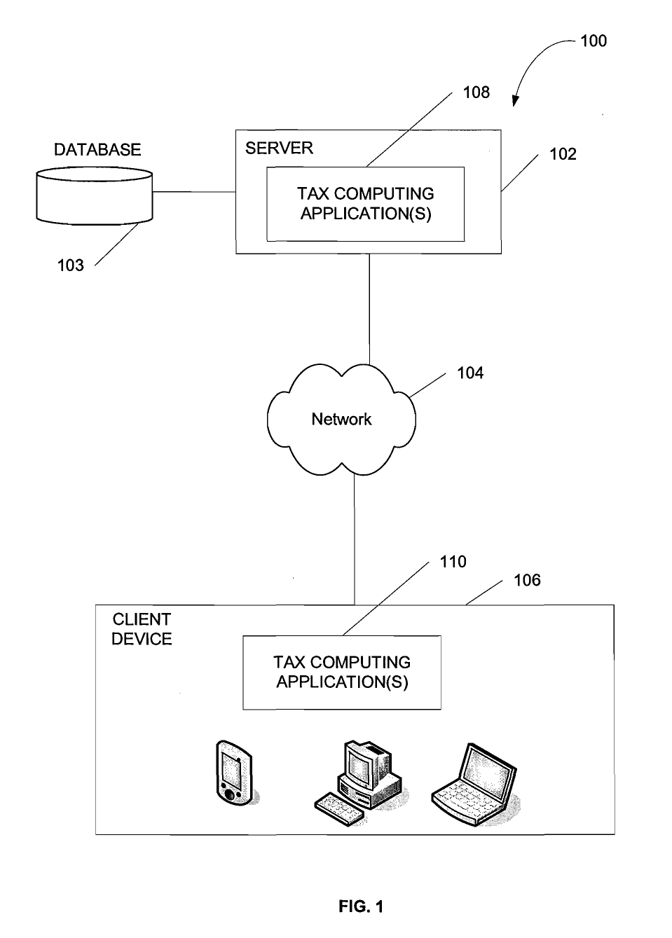

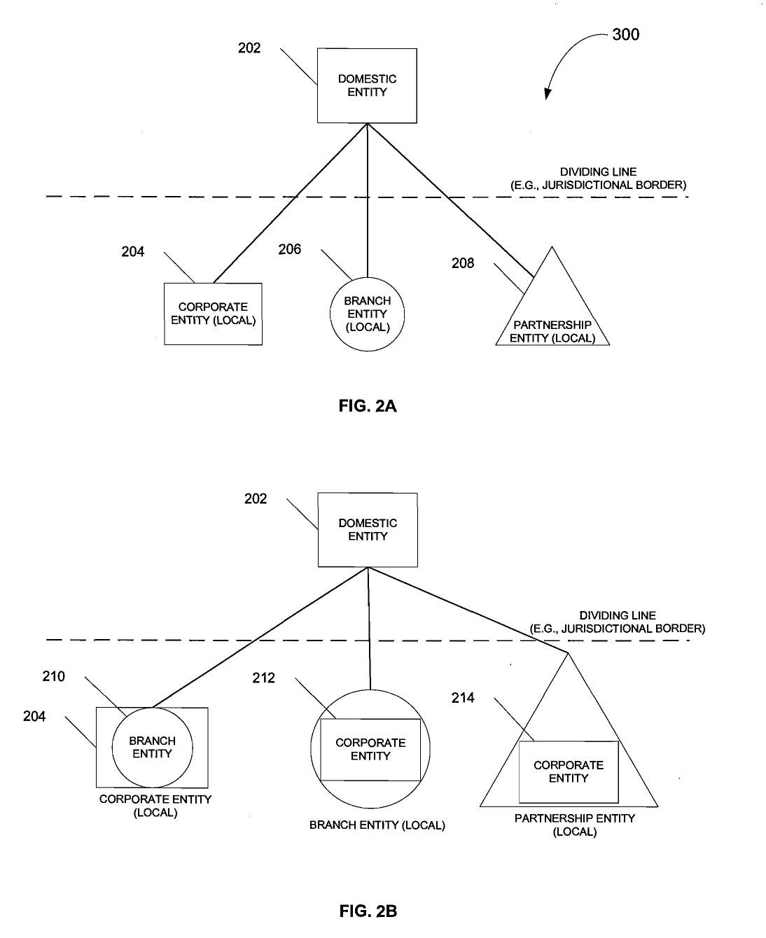

FIG. 1 is a diagram that illustrates an example embodiment of a tax computing system 100, which may be used to compute taxation data for a domestic entity or consolidated group of domestic entities based on business data associated with a change in a related (e.g., foreign) entity's business form, structure of type (e.g., corporation to branch, see FIG. 2). The taxation data with respect to changing an entity's form may be computed for its impact in a current year or may be computed for subsequent years in a forecasting analysis.

The tax computing system 100 includes a server 102, a database 103, a network 104, and a client device(s) 106. The client device 106 and the server 102 may include tax computing applications 108 and 110, respectively. The tax computing applications 108, 110 may be used in a multitude of configurations to execute the method and operations described herein. Additionally, the client device 106 may include any device (e.g., personal computer, laptop, personal digital assistant, etc.) that may execute one or more tax computing applications 110.

In one embodiment, the client device 106 may access, receive, communicate, and store data on the server 102 and database 103 through the network 104. Additionally, the client device 106 may remotely invoke tax computing functionality (e.g., via tax computing application 108) on the server 102 to process data communicated from the client device 106 or data associated with the client device 106 that may be stored locally in the database 103. In another embodiment, computation of tax data, for a domestic entity based on business data associated with a change in a subordinate entity's business form may be all or in part realized by executing some or all of the processes via tax computing application 110 locally on the client device 106.

The subordinate entity, in various embodiments, may be a foreign held entity, which may be elected to be treated as a different business form for all or part of the entity's tax year. It can be appreciated the tax computing system 100 may implement the method and operations described herein to initiate an election event to calculate, store and display the business data, including tax data, pertaining to the foreign entity prior to the election and after the election. This data may be stored and accessed locally at the client device 106, remotely on the database 103, or on other types of mediums known in the art (e.g., compact disk, etc.).

For simplicity, example embodiments described hereinafter will treat all child entities as foreign held entities with respect to a United States (US) parent entity and Unites States Tax law. However, in other embodiments, the same systems and methods described herein may be applied to a parent entity being a non-US entity in one jurisdiction and the child entity being held in another jurisdiction. Additionally, although many business forms exist, for simplicity three example business forms are discussed herein, corporations, partnerships, and branches. Foreign corporations held by a United States (US) entity may either keep generated income in the foreign jurisdiction or pass the income back to the US entity as a dividend. Foreign branch and partnership business forms are called flow through entities (FTE), in which income generated flows immediately and directly to their parent entity. As discussed in more detail below, corporations and FTEs are treated differently with respect to computing a US entity's tax liability.

FIGS. 2A and 2B are diagrams graphically illustrating a relationship with respect to tax treatment of an entity and its associated related (e.g., foreign) entities. In the example embodiment illustrated in FIG. 2A, the related entities of domestic entity 202 are represented by a corporate entity 204, a branch entity 206, and a partnership entity 208. These related entities are foreign entities owned by the domestic entity 202 and are illustrated prior to an election event (e.g., change business form) for taxation purposes. As illustrated, the corporate entity 204 is represented by a rectangle, the branch entity 206 is illustrated by a circle, and the partnership entity 208 by a triangle.

A dividing line 210 illustrates a jurisdictional border between the domestic entity 202 and the foreign entities. It can be appreciated the each of the foreign entities may be in the same foreign jurisdiction or one or more may be in a different foreign jurisdiction. In other embodiments, the jurisdictional border may be a domestic jurisdictional border (e.g., between states and/or territories).

Additionally, FIG. 2A graphically illustrates example embodiment of how the tax computing system 100 may create a multiple jurisdictional representations for the parent entity and each child entity, including grandchild entities, if any (e.g., a child of a child, not shown). The parent, child, grandchild, and so on entity structure may be referred to as an entity chain.

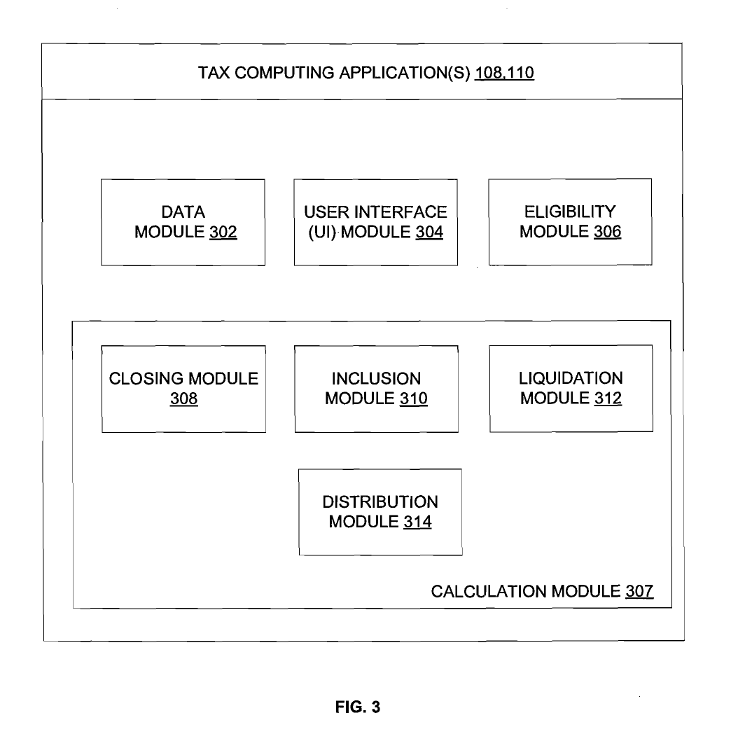

FIG. 2B specifically illustrates a diagram of an example embodiment of the change in business form of each foreign entity after an election event, the details of which are discussed below with respect to FIG. 3. As symbolically illustrated in this example, the corporate entity 204 (rectangle) now appears to the domestic entity 202 as a branch entity 210 (circle). Similarly, the branch entity 206 (circle) now appears to the domestic entity 202 as a corporate entity 212 (rectangle), and the partnership entity 208 (diamond) now appears to the domestic entity 202 as a corporate entity 214 (rectangle). The change in business form is only in view of the domestic entity for tax purposes and the foreign (or local) jurisdiction view is still of the original business form. The tax computing system 100 may then store and display each state, which corresponds to the business data pertaining to each business form. In this case for example, the tax computing system 100 maintains the business data associated with the original (local) business form, corporate entity 204, and the elected business form, the branch entity 210, as seen from the parent entity's jurisdiction. The first state associated with the pre-election business data and the second state associated with the post-election business data.

FIG. 3 is a block diagram illustrating an example embodiment of modules that may be used in an election event by the tax computing system 100. These modules include a data module 302, a user interface module 304, an eligibility module 306, and a calculation module 307 including a closing module 308, an inclusion module 310, a liquidation module 312, and a distribution module 314. In various embodiments, these modules operate all or in part on the tax computing applications 108, 110 on server 102 and the client device 106.

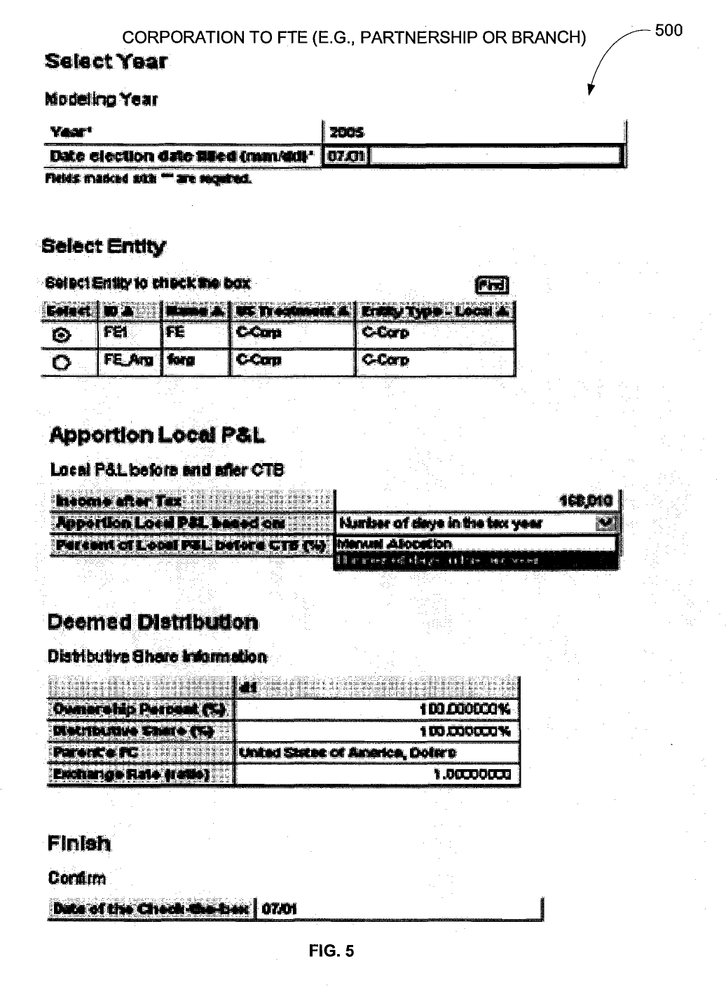

In one embodiment, the data module 302 receives and stores business data from various sources. For example, user input devices (e.g., from client device 106), data storage devices (e.g., database 103), and other data processing and storage systems, such as statutory consolidation systems used for the Securities and Exchange Commission's (SEC) required filing of consolidated financial statements. The user interface module 304 may be utilized to provide an interface for a user to enter business data, select one or more entities for an election event (e.g., check a box), select election criteria (e.g., election or projected election date) for tax computations and/or forecasts, and to display the user inputs and results composed of views and/or reports associated with the operation of the modules described herein (e.g., see FIGS. 5-7). In various embodiments, the user interface module 304 may provide and serve the user interface to the client device 106 from the server 102 via the network 104, or may provide the user interface locally on the client device 106.

In various embodiments, the user interface module may interact with at least the data module 302 to create multiple jurisdictional representations based on respective business data (entered and calculated) for the parent entity and each child (local) entity, including any grandchild entities, if any. Example embodiments may include the user interface module 304 generating and displaying a selectable control (e.g., UI tabs) between each local child entity or entity chain and the parent entity and between each jurisdictional representation of each entity.

In one embodiment, the user interface module 304 may provide additional user controls to execute various transaction scenarios impacting one or more jurisdictional representations of the entity with or without affecting or impacting other jurisdictional representations of the entity. A transaction and transaction data includes, inter alia, values associated with payments such as dividends, rents, royalties, interest, taxes, or other actions such as an election event described herein. The scenario may be a current scenario using current business data or a future scenario using projected business data or combination of current and projected business data. In various embodiments, the original jurisdictional representations are maintained (saved) and the scenarios generated may be saved and utilized in comparative reports generated on or via the user interface of the tax computing system 100.

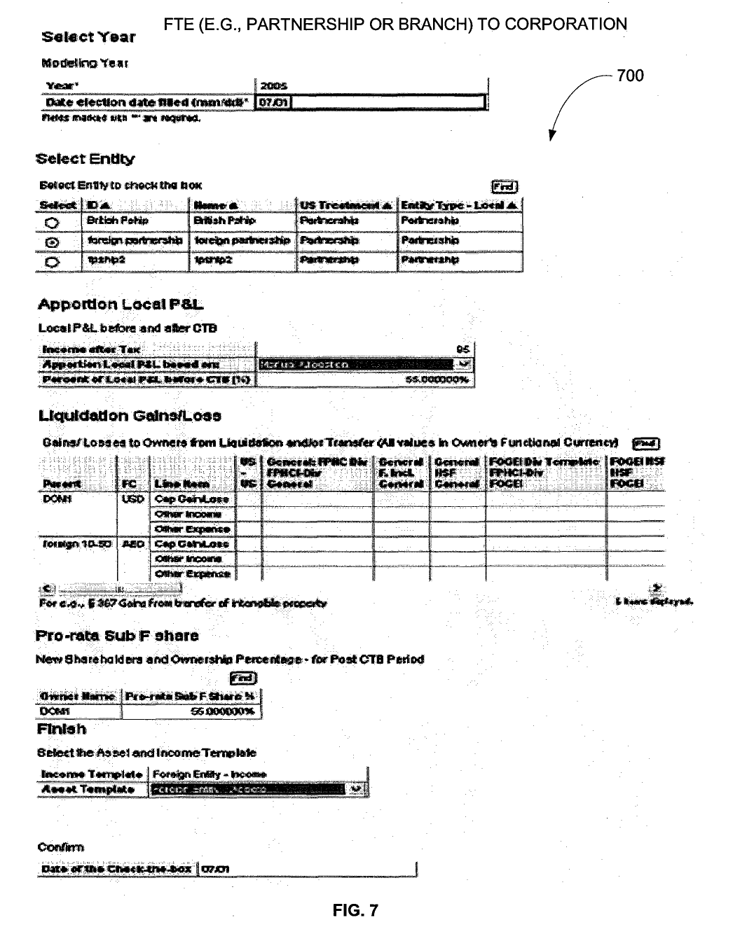

The user interface module 304 may in conjunction with other modules of the tax computing system 100 create and display a “wizard” type interface. In one embodiment, the wizard systematically displays in a logical order selectable inputs and data which guide a user through the operations of selecting an entity for an election event (e.g., see FIGS. 5 and 7).

In one embodiment, the user interface module 304 allows the user after an election event to move between displaying pre- and post-election event data for the foreign entity. Irrespective of the election event there is only one entity, one local (foreign jurisdiction) profit and loss (P&L), collectively “Local P&L”, and one local tax computation for the election event year. As a result, the user interface module 304 may then create selectable inputs, such as a common general tab and a local P&L tab between the pre- and post-election event periods. However, for a jurisdiction's (e.g., US jurisdiction) tax calculation purposes, the pre-election event and post-election event entities may be treated as two different entities. For example, one may be a flow through entity (FTE) and the other a non-FTE (e.g., corporation). Therefore, the user interface module 304 may create tabs in the UI for FTEs (US treatment) which are different from the tabs created for corporations.

In one embodiment, the user interface module 304 may display separate ownership tabs between pre- and post-election event period since the ownership structure could change before or after an election event. Therefore, the tax computing system 100 and its associated modules may track, process and display different attributes for a corporation than for a branch or partnership.

The user interface module 304, according to an example embodiment, creates and provides a user a display of tabs or other selectable controls on a user interface to seamlessly navigate between the pre- and post-election event period earnings, profits, and taxes (E&P), and transactions and distributions for a selected entity for a selected election event year.

In most cases the user interface module 304 displays an election event entity (pre- and post-election event) among a list of entities as separate entities. The user interface module 304, according to an example embodiment, may use filters to selectively display data to the user. For example, in a screen where only corporations are displayed, both pre- and post-election entities will not be displayed since pre- and post-election entities cannot both be corporations.

In various embodiments, the user interface module 304 may use one or more validation rules to determine in which display the pre-election event and post-election event is to be treated as one instance (entity) and where it is to be treated as separate instances (entities). The validation rules for treating the pre-election election event and post-election event as one entity may include the following: a) for creating an intercompany transaction, when selecting the payee or payor of a transaction, display the election event entity as one entity, the transaction is routed for US Earning and Profits impact by the system to either pre- or post based on the date of the transaction and the election event date while for the local P&L no distinction is required; b) selecting and displaying parents of an entity; c) entity count by entity type; number of corporations vs. number of branches or partnerships; and c) reporting on just local P&L values or based on local treatment alone.

The eligibility module 306 may be used to determine if a foreign entity (e.g., corporate entity 204) is eligible for an election event. This may be determined prior to a user selecting the election event or may be determined after a user selects the election event for all or only the selected foreign entity. Additionally, there may be conditional requirements based on how the foreign entity is structured in its jurisdiction. For example, certain large foreign entities (equivalent to the US corporations) are always treated as corporations for US tax purposes. Consequently, a user (taxpayer) may not select an election event on such entities.

Table 1 illustrates examples of required conditions for particular election events (e.g., corporation to branch), which according to one embodiment is verified by the eligibility module 306 and data (e.g., how many shareholders in the corporation) entered by a user or retrieved from a local or remote storage location, such as database 103. The term, “Hybrid” refers to a local corporation treated as a branch or partnership for US tax purposes, i.e. an entity that has a different US tax treatment than its foreign treatment.

TABLE 1

| Pre-Election | Post-Election | |
|---|---|---|
| Event | Event | Required Condition |
| Corporation | Branch | When the corporation has only |
| | | one shareholder, it becomes a |
| | | Hybrid Branch. |
| Corporation | Partnership | When the corporation has two or |
| | | more shareholders, it becomes a |
| | | Hybrid Partnership. |
| Partnership | Corporation | None. |
| Branch | Corporation | None. |

In one embodiment, to determine if a foreign entity is eligible for an election event, the eligibility module 306 checks if and when the last election event was made for the selected foreign entity. A jurisdiction may have rules or laws that determine how often an election event may be made. For example, in the US an election event may be made once every five years. The eligibility module 306 may determine from past data and provide an indication to the user via the user interface module 304 current eligibility, or alternatively future eligibility for an election event.

In an election event, regardless of the business form election, calculations based on a jurisdiction's rules and laws are made to calculate the parent entities tax liability with respect to one or more child entities located in another jurisdiction. The modules including the closing module 308, the inclusion module 310, the liquidation module 312, and the distribution module 314, according to one embodiment, are used to process business data from the one or more foreign entities to make the tax liability calculations.

For simplicity, all treatments, events, and calculations described with respect to these modules pertain to US tax treatment of the parent entity. For US purposes, there are two operations associated with an election event. The first operation is a closing of the tax year and the second operation is a deemed liquidation of the entity, in which the earnings, profits and assets of the entity are first distributed to the one or more parent entities and the one or more parent entities then re-invest the assets back in the newly formed entity (e.g., branch). The details of which are discussed in further detail below with respect to the description of the liquidation module 312.

In one embodiment the calculation module 307 may analyze and filter events and data that may not be considered in the calculations set forth below. For example, non-taxable events may be discovered, automatically or via external input, and set aside for some calculations. An example event includes one or more intercompany transactions between commonly owned branches or between parent and branch child. In some jurisdictions, income and expenses between commonly owned entities are not to be considered in calculating the parent companies tax liability and therefore must be filtered out subsequent to a change in form of an entity under a jurisdiction's rules.

The closing each current tax year (CY) year for a corporation means closing of all E&P (earnings, profits, and taxes) accounts. For branches and partnerships, this means all their earnings may be included in their respective foreign parent's CY E&P or US parent's taxable income. For US tax purposes, each CY is closed in succession and the results in the form of summary E&P and taxes are stored in accumulating “pools” that include all years added together. The US taxes worldwide income of its “citizens,” then provides a credit or deduction for payment of foreign taxes. The worldwide income is referred to as E&P when held overseas and the E&P pools is associated with a tax pool for each entity that is treated as a corporation for US tax purposes, branches or partnerships needing no pools since all income and taxes flow immediately. When the income comes into the US, the E&P is then called “Taxable Income” and “Creditable Taxes.”

In various embodiments, creating tax data based on having both the US tax code modeled as well as the underlying foreign taxation of the elected child entity modeled may be advantageous to the parent entity. For example, if an originating dividend flows up through a chain of foreign entities subordinate to the elected entity to the parent entity, prior to arriving at the parent (domestic) entity it may incur taxation in each of the foreign jurisdictions resulting in an arriving dividend less than the originating dividend. If the dividend recipient is a corporation for US tax purposes, this taxation will result in an increase in the tax pool of such entity. For US tax purposes, the taxes associated with an outgoing distribution, known as “gross-up”, are based upon the ratio of the tax pool over the E&P+tax pool. This intermediate foreign taxation should be accounted for in determining the amount of E&P and taxes processed by the liquidating module. The liquidation module 312 in analyzing the business data automatically accounts for the additional taxation in each of the foreign jurisdiction(s). It accumulates into each successive subordinate entity tax pool such incremental taxation and processes outgoing dividends based upon such accumulated pool values per the ratio referred to above. In this manner it properly determines the amount of creditable taxes available for the electing entity and therefore processed by the liquidation module at the time of the election event (check the box) processing.

The closing module 308 operates to close the E&P accounts of the entity undergoing an election event. These accounts are closed as of the end of the day in which the election is made.

In one embodiment to close the accounts associated with an election event to treat a corporate entity as a flow through entity (e.g., a partnership or branch), the closing module 308 processes the CY pre-election event subpart F E&P and corresponding indirect taxes through subpart F tests, and distributes it pro rata to all domestic ancestors. Subpart F is Earnings and Profits of controlled foreign corporations which but for regulations under section sections 951-964 of the Internal Revenue Code would otherwise be deferred. Therefore, Subpart F E&P is immediately taxable in the US whether distributed or not.

The closing module 308 then flags as distributed to the parents the leftover E&P and taxes up until the election event date. The total distribution amount may be determined by the closing module 308 using the formula:

Distribution=BOY(beginning of year)E&P+CY pre-election event E&P−Σ(distributions made until that point).

CY E&P until election event date is the sum of: 1) pro-rated share of local P&L and any adjustments to US E&P until the election event date; 2) all incoming and outgoing transactions in that scenario year on or before the election event date; and 3) all incoming partnership and branch inclusions that happen in that scenario year on or before the election event date. Whether a partnership or branch inclusion is to be added in pre-election event or post-election event E&P is explained below.

The pro rated share may be derived by the closing module 308 based on: 1) a user selected percentage value captured in the election event tab of the entity (e.g., via the UI module 304); or 2) calculating a percentage based on a “number of days” selected by the user, the calculation being the number of days after previous tax year end date up to the election event date (including that date), divided by 365. In one embodiment, the closing module 308 may invalidate the US E&P impact of certain intercompany transactions while not changing the local P&L impact. Intercompany transactions subject to E&P impact invalidation are those that as a result of the recharacterization of the electing entity to a FTE would thereby make the transaction parties both FTE's under common control. This common control may be represented by direct or indirect (through layers of FTE's) ownership by a 3^{rd} entity, or by one FTE or parent legal entity owning a controlling stake in the other FTE. In each case, such transaction may be viewed as self dealing within the same entity, since branches and majority owned partnerships are considered part of the parent entity.

In one embodiment to close the accounts associated with an election event to treat a FTE (flow through entity) as a corporate entity, the closing module 308 processes the business data of the FTE as if the date of the election event is the closing date of the tax year.

In the case where the election event is applied to a partnership, the closing module 308 processes data corresponding to the income of all partners as of the date of the election event, where the processing includes calculating the total partnership income divided among partners based on the CY pre-election event E&P of the partnership. After this amount is calculated, the an allocation process and optional adjustment processes are performed by the closing module 308 to calculate pro-forma K-1s for each parent. The pro-forma K-1s are provided to each owner of a partnership under US tax law. They represent the amount of partnership income and foreign taxes includable in each partner's US income and is included in each respective foreign parent's CY E&P or US parent's taxable income.

In the case where the election event is applied to a branch to convert it to a corporation for US tax purposes, the closing module 308 processes the CY pre-election event E&P of the branch so that it is attributed to the parent up to the election event date. The process to determine the CY pre-election event E&P of a partnership and a branch is same as that discussed above with respect to the corporation.

The inclusion module 310, according to one embodiment, may be used to determine whether an inclusion is required of the incoming partnership or branch, and to make any necessary calculations pertaining to the inclusion. An inclusion is the process of flowing K1 or branch E&P and taxes into parent E&P and taxes, or if domestic, income and creditable taxes

Whether an incoming child partnership inclusion is included in pre-election event or post-election event is determined based on whether the child partnership undergoes an election event. If the child partnership of an election event entity remains a partnership throughout the year, then the inclusions from such entity would be included by the inclusion module 310 in the post-election event E&P. However, if the child partnership of the election event entity undergoes an election event in the same year, then the inclusion module 310 applies the inclusion on the date of the election event of the child partnership. If the date precedes or coincides with the election event of the election event entity (parent), it will be included be the inclusion module 310 in the pre-election event E&P of the parent. Otherwise it will be included in the post-election event E&P.

In another embodiment, if a child FTE is a branch, a different treatment by the inclusion module 310 may be selected for the election event depending on when the election event occurs. If the child never makes an election (e.g., checks the box on the UI) in the election event year, then the inclusion module 310 may pro-rate the child's CY E&P using the same ratio used to pro rate the parent's pre-election event and post-election event local P&L. The pro-rata part that corresponds to the pre-election event is included in the pre-election event E&P of the parent. The pro-rata part that corresponds to the post-election event part is included in the post-election event E&P of the parent.

If the child partnership of an election event entity remains to be partnership throughout the year, then inclusions from such entity would be included in the post election event E&P. If the child partnership of the election event entity undergoes an election event in the same year, then inclusion happens on the date of the election event of the child partnership. If such date precedes or coincides with the election event of the election event entity (parent), it is included in the pre-election event E&P of the parent. Otherwise it is included in the post-CTB E&P.

If the child is a corporation that undergoes an election event to become a branch in the election event year, then the inclusion module 310 processes business data according to the following: 1) if the child undergoes the election event on the same date as the parent, then include the entire child's post-election event E&P in the parent's post-election event E&P and the pre-election event E&P of the child then comes through to the pre-election event of the parent in form of a deemed liquidation distribution discussed below; 2) if the child checks the box after the parent, then the deemed liquidation distribution is included in the post-election event E&P of the parent; and 3) if the child checks the box before the parent, then determine: a) a factor based on the number of days between parent's election event date and next tax year end of the child, divided by number of days between child's election event date and next tax year end of the parent (this is the measure of what portion corresponds to the pre-election event part of the parent during the period the child is a branch); b) multiply the child's post-election event E&P by the factor and include it in the pre-election event E&P of the parent; and c) multiply the child's post-election event E&P by (1 minus the factor) and include it in the post-election event E&P of the parent.

In one embodiment, when an entity has been selected for an election event, the liquidation module 312 performs a deemed liquidation on the election event entity (e.g., child entity) and a new entity is formed. In the liquidation process the parent receives all the earnings, profits and assets of the entity and subsequently invests the received assets into the newly formed entity.

If the liquidation module 312 determines the election event entity is a foreign corporation before the election event, then there can be no gains or losses in the asset transfer and the basis of each parent in the newly formed flow through entity is the same as its EOY (end of year) basis in the corporation.

If the liquidation module 312 determines the election event entity is a foreign partnership or a branch before election event, and becomes a corporation as result of election event, then a) there can be some gains or losses to the parents from intangibles and captured by the liquidation module 312 for each parent in each basket; and b) the basis of the parent in the newly formed corporation is set accordingly and if the election event entity is a partnership before the election event date, then the BOY basis is the same as EOY outside basis of the parent in the partnership.

Such gains or losses can either be capital gains/losses or ordinary gains/losses. In one embodiment, the tax computing system 100, and specifically the user interface module 304 provides an interface for a user to enter business data such as gains and losses for each parent in parent's foreign corporation (FC) in any basket for the following line items, capital gains/losses, other income, and other deductions (e.g., see FIG. 7). In another embodiment, the business data is at least partially, if not all, provided by a data storage device, such as the database 103.

Such gains are added to the parent's CY E&P to the respective income lines, along with the partnership or branch inclusion. If the parent undergoes election event and if partnership or branch inclusion from this entity is pro-rated between parent's pre-election event E&P and post-election event E&P, these gains and losses may also be similarly pro-rated before being included in such E&P. If the election event entity is a branch before the election event date, then the user via the user interface may enter BOY basis for the newly formed corporation for its parent.

When a foreign entity changes its US tax treatment from corporation to a FTE (e.g., branch or partnership), it is considered to distribute its E&P in a deemed distribution (election event distribution). In one embodiment, this election event distribution is processed separately by the distribution module 314 after processing all other regular distributions made during the year until the election event date.

The distribution module 314 according to one embodiment, determines whether or not the distribution is a regular distribution or an election event distribution. If it is an election event distribution, the distribution module 314 along with the user interface module 304 prevents a user from entering specific values the user would other be able to input in a regular distribution. These values include the amount of distribution and the date of the distribution set to the election event date. The amount of distribution is given by the formula: Amount=BOY E&P+CY pre-election event E&P−Σ(distributions made during that year on or before the election event date). In one embodiment, this amount of distribution is dynamic and determined by the formula upon each iteration of tax calculation. This allows for the underlying pre-event E&P of the electing entity to change without the user having to modify the liquating distribution. The CY pre-election event E&P is explained above with respect to the description of the closing module 308.

The operations associated with the calculation for election event year by the distribution module 314 includes determining CY pre-election event E&P, processing all regular distributions made during the year on or before the election event date, determining the amount of election event distribution, and processing the election event distribution (alone) just like any other distribution. Because the total distribution amount is always equal to the E&P amount, there cannot be any return of capital or gains for the parent from an election event distribution.

Since it is a deemed distribution just for US tax purposes, there will be no local tax impact of this distribution to the parents. Therefore, the distribution module 314, for each parent that receives a share in this distribution, sets the local taxable impact of the distribution to zero in the local jurisdiction and the Withholding taxes on the distributed amounts to zero.

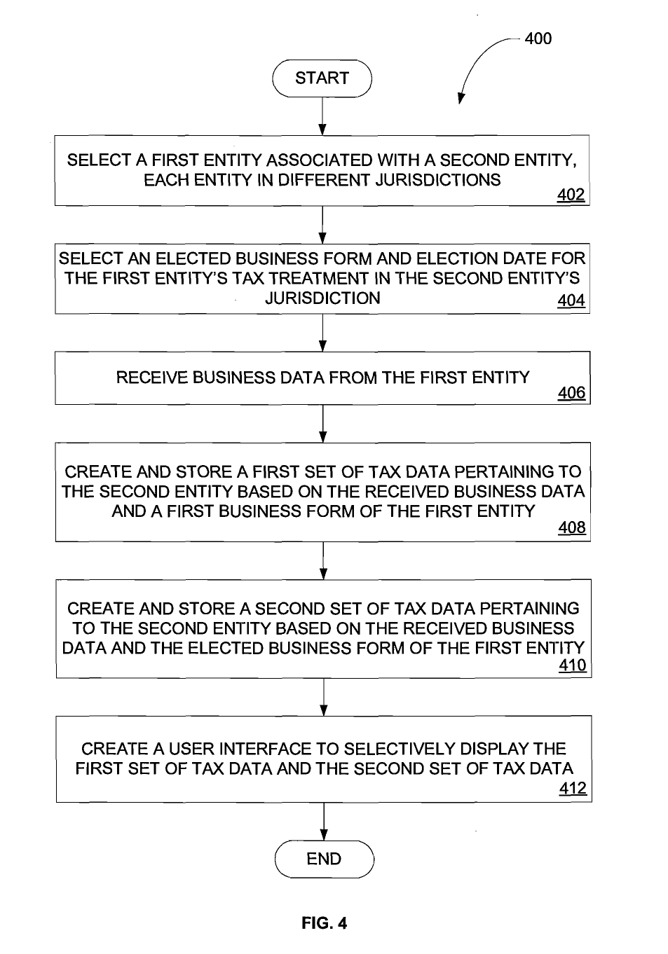

FIG. 4 is a flowchart 400 illustrating an example embodiment of the operations for an election event to treat an elected entity in a first jurisdiction as a different business form for taxation purposes of its parent entity in a second jurisdiction.

The flowchart 400 starts at operation 402 where, according to one embodiment, a user may select for election a first entity, which is associated with a second entity, and the first and the second entity are in two different jurisdictions. For example, the first entity may be in the US and the second entity in Germany. The user, at operation 404, selects an elected business form and election date for the first entity's tax treatment in the second entity's jurisdiction. For example, a parent (second) entity in the US (United States) may want to make an election to treat a foreign corporate (first) entity as a foreign branch entity for US tax purposes.

At operation 406, the system (e.g., tax computing system 100) receives business data from the first entity and at operation 408 the system creates and stores a first set of tax data pertaining to the second entity based on the received business data and a first business form of the first entity. For example, if the first business form is foreign corporation, the system will create the first tax data based on the date of the election event and the rules associated with the tax treatment of a foreign corporation (the first business form).

The system at operation 410 creates and stores a second set of tax data pertaining to the second entity based on the received business data and the elected business form of the first entity. For example, if the second business form is foreign branch, the system will create the second tax data based on the date of the election event and the rules associated with the tax treatment of a foreign branch (the second business form).

At operation 412, the system creates a user interface to selectively display the first set of tax data and the second set of tax data. In various embodiments, the user may actively select which set of data to view and generate reports pertaining to each set of tax data.

In one embodiment, the election date selected in operation 404 is a date within the current tax year. In other embodiments, various projected election dates outside of the current tax year may be selected and the first and second set of tax data may be computed based on projected business data.

FIGS. 5 through 7 are screenshots of example embodiments for selecting election event to treat an elected entity in a first jurisdiction as a different business form for taxation purposes of its parent entity in a second jurisdiction. FIG. 5 is screenshot 500, according to one embodiment, illustrating the input selections for electing to treat a foreign corporation as a FTE (flow through entity). In this example since the treatment for a branch or a partnership is the same, the only election is to a FTE. However, in other embodiments the treatment may not be the same for an election to a branch versus a partnership, and that choice would be presented in the user interface.

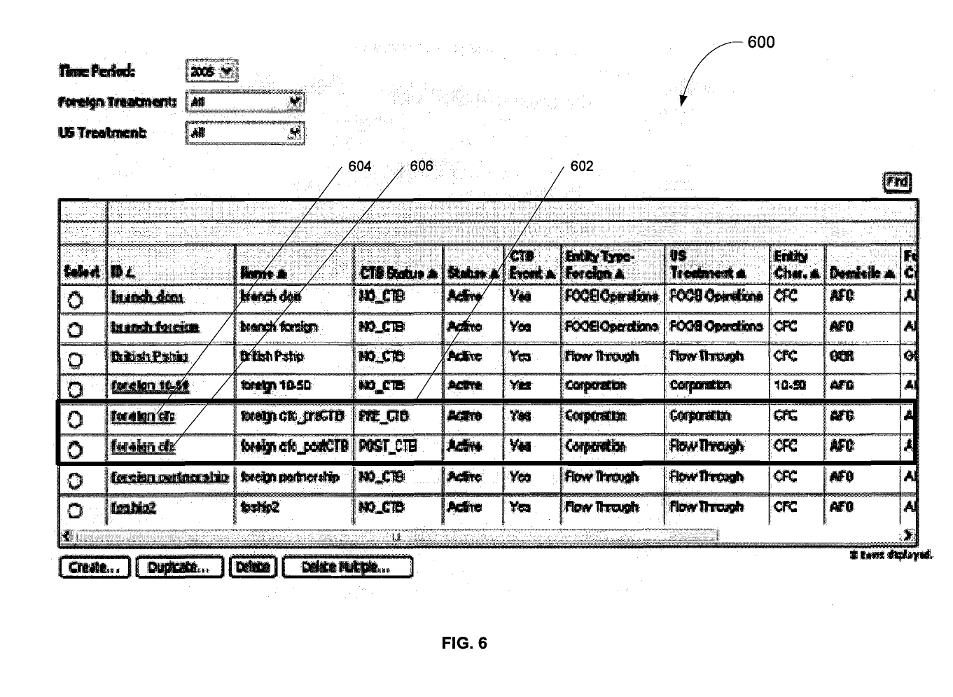

FIG. 6 is a screenshot 600, according to one embodiment, illustrating the selectable results of the election from a corporate to a FTE. Section 602 is the portion of the table that illustrates the pre- and post-election event (CTB) duality of the US treatment of foreign entity. In one embodiment, a selectable link 604 and a selectable link 606 may be selected to generate on the user interface a data report for the pre-election event US treatment (corporation) and the post-election event US treatment (flow through), respectively. In other embodiments, a user may toggle between the two treatments by one or more of many know ways in the art, such as by tabs or by menu bar selections.

FIG. 7 is a screenshot 700 illustrating an example embodiment of a user interface provided to a user for electing to treat a foreign FTE as a corporation. As illustrated, the user may select the modeling year, the entity to elect, an apportionment value as a percentage of the local P&L (profit and loss), enter data pertaining to liquidation gains and loss, and a pro-rata sub F share (see definition with respect to the description of FIG. 3). In another embodiment, the apportionment value is based on the number of days as a percentage the elected entity is under the first business form.

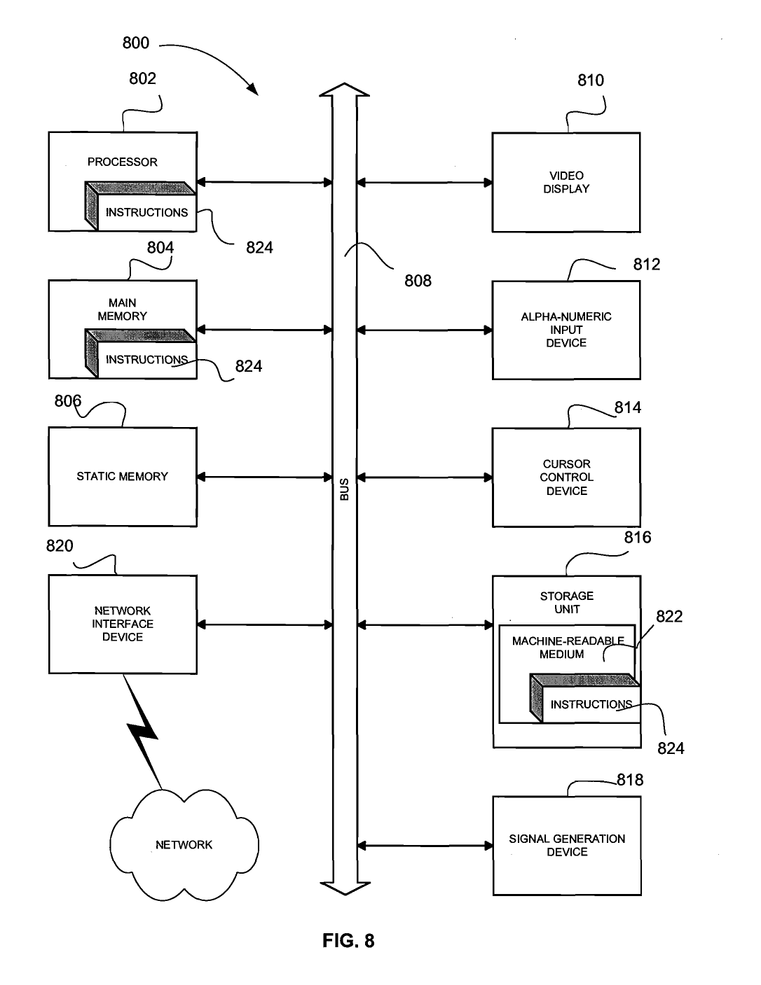

FIG. 8 shows a diagrammatic representation of machine in the example form of a computer system 800 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, including:
receiving business data pertaining to a first entity, the first entity being associated with a second entity;
creating first tax data associated with the second entity based on the business data and a first business form of the first entity;
creating second tax data associated with the second entity based on the business data and a second business form of the first entity; and
storing the first tax data and the second tax data.

2. The method of claim 1, wherein the receiving of the business data includes receiving a portion of the business data as inputs from at least one from a group including a user interface and a data storage.

3. The method of claim 1, wherein the business data includes an election date after which the first entity is represented by the second business form.

4. The method of claim 3, including dividing a first portion of the business data pertaining to the first business form and a second portion of the business data pertaining to the second business form based on the election date.

5. The method of claim 3, including:
determining from the business data if a dividend has been received from an entity in a chain of entities subordinate to the first entity;
determining from the business data if a tax has been paid on the dividend in a jurisdiction other than a jurisdiction of the second entity; and
including in the first tax data and second tax data at least one from the group including creditable taxes and deductible expenses associated with the payment of the tax.

6. The method of claim 3, wherein the election date is a projected election date and the business data is projected business data.

7. The method of claim 3, wherein the creating of the first tax data includes using an apportionment value included in the business data to determine a portion of income of the first entity to defer, wherein the first entity is a foreign corporation.

8. The method of claim 3, wherein the creating of the first tax data includes calculating an apportionment value based on a number of days the first entity is under the first business form to determine a portion of the first entity's income to defer, wherein the first entity is a foreign corporation.

9. The method of claim 1, including creating a user interface to selectively display the first tax data and the second tax data.

10. A system, including:
a data module to receive business data pertaining to a first entity, the first entity being associated with a second entity;
a calculation module to create first tax data associated with the second entity based on the business data and a first business structure of the first entity and to create second tax data associated with the second entity based on the business data and a second business structure of the first entity; and
the data module to store the first tax data and the second tax data.

11. The system of claim 10, wherein the data module to receive a portion of the business data as an input from at least one from a group including a user interface and a data storage.

12. The system of claim 10, wherein the business data includes an election date after which the first entity is represented by the second business structure.

13. The system of claim 12, wherein the calculation module is to divide a first portion of the business data pertaining to the first business structure and a second portion of the business data pertaining to the second business structure based on the election date.

14. The system of claim 12, wherein the calculation module is to determine from the business data if a dividend has been received from an entity in a chain of entities subordinate to the first entity and to determine from the business data if a tax has been paid on the dividend in a jurisdiction other than a jurisdiction of the second entity, and to include in the first tax data and second tax data at least one from the group including creditable taxes and deducible expenses associated with the payment of the tax.

15. The method of claim 12, wherein the calculation module is to calculate the first tax data and the second tax data based on the election date being a projected election date and the business data being projected business data.

16. The system of claim 12, including a distribution module to use an apportionment value of the business data to determine a portion of income of the first entity to defer, wherein the first entity is a foreign corporation.

17. The system of claim 3, including a distribution module to calculate an apportionment value based on a number of days the first entity is under the first business structure to use the calculated apportionment value to determine a portion of the first entity's income to defer, wherein the first entity is a foreign corporation.

18. The system of claim 10, including a user interface module to create a user interface to selectively display the first tax data and the second tax data.

19. A machine readable medium comprising instructions, which when executed by a machine, cause the machine to:
to receive business data pertaining to a first entity, the first entity being associated with a second entity;
to create first tax data associated with the second entity based on the business data and a first business form of the first entity and to create second tax data associated with the second entity based on the business data and a second business form of the first entity; and
to store the first tax data and the second tax data

20. The machine readable medium of claim 19, wherein the instructions, which when executed by a machine, cause the machine further to divide a first portion of the business data pertaining to the first business form and a second portion of the business data pertaining to the second business form based on an election date, wherein the election date in included in the business data and is a date after which the first entity is represented by the second business form.

21. A system, including:
means for receiving business data pertaining to a first entity, the first entity being associated with a second entity;
means for creating first tax data associated with the second entity based on the business data and a first business form of the first entity;
means for creating second tax data associated with the second entity based on the business data and a second business form of the first entity; and
means for storing the first tax data and the second tax data.

22. A method, comprising:
receiving first business data associated with a parent entity located in a first jurisdiction;
receiving second business data associated with a child entity located in a second jurisdiction;
processing the first business data and the second business data to create a first representation and a second representation of the parent entity and child entity, respectively.

23. The method of claim 22, further including:
receiving transaction data pertaining to the child entity; and
processing the transaction data and at least a portion of the second business data to create a third representation of the child entity.

24. The method of claim 22, further including:
receiving transaction data pertaining to the parent entity; and
processing the transaction data and at least a portion of the first business data to create a third representation of the parent entity.

25. The method of claim 22, further including:
creating first tax data associated with the parent entity based on the first business data and a first business form of the first entity;
creating second tax data associated with the second entity based on the business data and a second business form of the first entity
